(19) United States
(12) Patent Application Publication
(10) Pub. No.: US 2021/0232110 A1
(43) Pub. Date: Jul. 29, 2021

(54) SYSTEM AND METHOD FOR GATHERING AND ANALYZING FUEL CONSUMPTION AND DEMAND INFORMATION OF A BUILDING

(71) Applicant: Dead River Company, Inc., South Portland, ME (US)

(72) Inventor: Steven Jacobs, Brewer, ME (US)

(73) Assignee: Dead River Company, Inc., South Portland, ME (US)

(21) Appl. No.: 16/775,741

(22) Filed: Jan. 29, 2020

(51) Int. Cl. G05B 19/042; G01J 5/00

(52) U.S. Cl. CPC G05B 19/042; G05B 2219/25252; G05B 2219/2648; G01J 5/0018

(57) ABSTRACT

A system and related method to analyze operation of a heating system of a building based on fuel consumption and fuel demand of the building. The system includes a database of information about the heating system of the building, a first sensor set arranged to gather fuel consumption information and a second sensor set arranged to gather fuel demand information within the building. The system includes a fuel usage and demand analysis function configured to analyze data from the first sensor set and from the second sensor set to output a determination of operation of the heating system based on consumption information and demand information.

### BACKGROUND OF THE INVENTION

### 1. Field of the Invention

The present invention relates to systems and methods for gathering information about fuel usage and demand. More particularly, the present invention relates to gathering such information, analyzing it and making assessments and recommendations about fuel usage and demand. Still more particular, the present invention relates to effective, reliable and accurate fuel consumption and demand information that can be used to improve fuel consumption, provide diagnostic data and identify heating system failure conditions, and characterize demand associated with that consumption.

### 2. Description of the Prior Art

Fuel used to heat and power buildings requires a regular and substantial financial investment over time. In addition, ensuring that the fuel is available as needed and that the equipment associated with using that fuel is functioning are often two critical conditions for any homeowner or business owner. As a result, we spend, or at least should spend, time and effort monitoring and maintaining fuel supply and fuel-using equipment.

As an example, homeowners in cold climates, such as the northern portion of the United States, require home heating fuel to generate heat to keep themselves warm in winter months. That fuel may be heating oil, gas, or cellulose-based material. Under fairly common temperatures in the north, heating fuel usage can be substantial. For a typical home, ordinary usage for those consumers requiring batch supply, such as consumers with fuel tanks for heating oil, can result in complete supply consumption in a matter of weeks. While there are mechanisms for observing the amount of fuel remaining in a tank, those mechanisms may not be as accurate as desired and, as a result, fuel may run out before the next delivery occurs. That can be catastrophic in terms of life-threatening temperatures that may be experienced, as well as frozen pipes that can lead to extensive building damage. Further, that fuel consumption information does not provide information about the ability of the heating system consuming that fuel to provide necessary and desired heating throughout the building.

Aside from the importance of ensuring that a fuel supply is provided when needed, there is also a value in analyzing fuel consumption. That information can be important in determining equipment inefficiencies and defects, and excess usage, for example. That type of information is valuable with respect to conditions of an individual building, such as a home. More broadly, fuel consumption and fuel demand information can be used to analyze equipment and building information of interest. For example, but without limitation, current fuel consumption determination mechanisms are inadequate in identifying the reasons for significant deviations in expected fuel consumption reflective of some inadequacy in the building heating system. There may be an ability from current information gathering mechanisms to establish that a deviation from a norm exists but without a suitable means to determine the reason for such deviation.

Current fuel monitoring systems are limited. They include single sensors that are positioned on or near fuel tanks and/or fuel burners. Such sensors associated with fuel tanks typically detect fuel level within the tank. Those sensors provide a general sense of remaining fuel but do not provide a particularly accurate picture and so just give an approximation of consumed fuel rather than a precise measure. Such sensors associated with fuel burners require an accurate understanding of the burner efficiency, with a standard formula used to convert burner operation with fuel consumed for that operation. This, too, can be only approximate. These sensors may be used to roughly measure fuel consumption rate over a broad time period, but they do not provide adequate timely feedback about consumption rates reflecting usage deviations. There also exist some sensors that are coupled to fluid conduits associated with hot water or steam transfer. Use of these sensors also fails to provide a highly accurate picture of fuel consumed (and, therefore, fuel remaining). Moreover, these sensors fail to provide a broader picture of how, where and/or when the fuel is being consumed. They also fail to provide enough information suitable for analyzing equipment operation, broader trends, or other information of interest associated in any way with fuel consumption.

What is needed is a fuel usage information gathering and analysis system and method capable of relatively simple configuration with reliable accuracy. What is also needed is such a system and method that can be used to gather and analyze information associated with fuel-using equipment operations of a building; that is, fuel demand.

### SUMMARY OF THE INVENTION

It is an object of the present invention to provide a fuel usage information gathering and analysis system and method capable of relatively simple configuration with reliable accuracy. It is also an object of the invention to provide such a system and method that can be used to gather and analyze information associated with fuel-using equipment operations.

These and other objects are achieved with the present invention, which combines a set of sensors with one or more computer programs configured to analyze information gathered from the sensors to output information of use in a range of fuel consumption and demand diagnostic determinations.

The system includes at least one sensor for sensing electrical signals associated with turning a heat generation apparatus on and off. The heat generation apparatus may be a heating unit, which may be a furnace or a boiler, a hot water heater, and/or other heating devices. The heat generation apparatus may be considered to be part of a complete heating system that also includes thermostats, controllers, piping, ducting and the fuel tank. The system also includes one or more sensors for sensing electrical signals associated with one or more thermostat zones calling for heat and ending that call. That is, the system includes at least one sensor coupled to each heat generation apparatus and at least one sensor coupled to each demand element, such as a thermostatic demand element. The system of the present invention is particularly effective in those heating systems with constant fuel flow rate, regardless of the particular fuel type.

The system further includes a signal processor or microcomputer coupled to the one or more sensors for receiving information about the sensed electrical signals and either calculating directly or forwarding sensed signals to a computing device for calculating, from that information start and stop times and duration of activity for the operation of a heating system used to heat water and rooms. That information, coupled with furnace configuration, such as pump pressure and fuel nozzle parameters, for example, can be used to determine fuel consumption and demand.

The results of information analysis by or through the processor may be communicated to and instructions exchanged with, a remotely located central system. Communication may occur wirelessly, such as through a radio exchange system such as wireless routing and internet connection. The gathered information may be further examined for information of value to the building owner, such as whether additional fuel must be ordered, whether excess heating is being used in a room or to generate hot water, and individual building information may be combined to provide general heating information about a building type, building location.

These and other advantages of the present invention will become more apparent to a person of skill in the field of the invention upon review of the following detailed description, accompanying drawings and appended claims.

### BRIEF DESCRIPTION OF THE DRAWINGS

FIG. 1 is simplified representation of primary components of the system of the present invention.

FIG. 2 is a simplified block diagram of primary components of the system of the present invention used to carry out steps of the methods of the present invention.

### DETAILED DESCRIPTION OF THE INVENTION

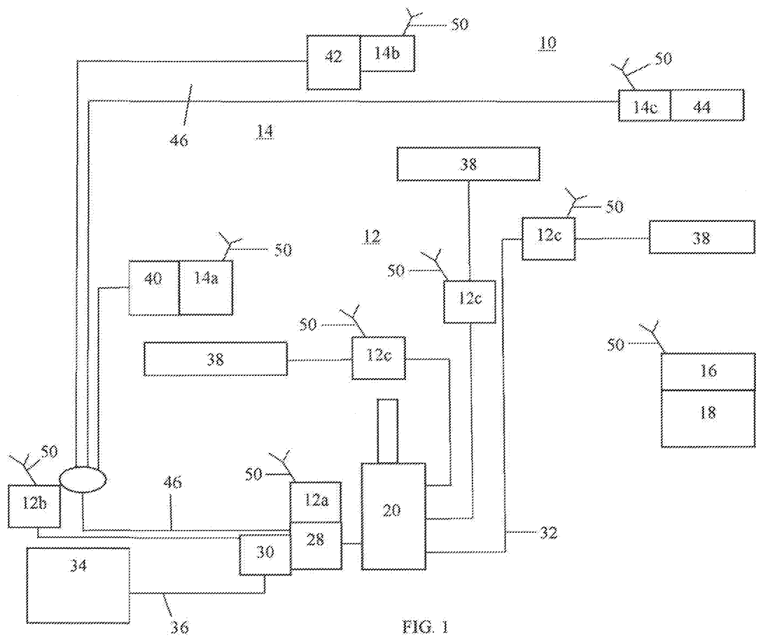

A fuel usage information gathering and analysis system 10 is represented in FIG. 1. The system 10 includes a first sensor set 12, a second sensor set 14, a signal processor 16 and an associated computing device 18 that may or may not include the signal processor 16. The first sensor set 12 represents one or more sensors 12a-12c used to gather information associated with the operation of a fuel burning system such as a heating unit 20 but not limited thereto. The second sensor set 14 represents one or more sensors 14a-14c used to gather information associated with demand based on the operation of one or more thermostats 40-44 or other types of devices used to identify the actions of thermal measuring and heat activation functions. That is, information gathered from the first sensor set 12 is used to measure fuel consumption while information gathered from the second sensor set 14 is used to identify demand associated with the fuel consumption. Prior fuel usage analysis systems have been limited to examining only the operation of the fuel consumption apparatus (i.e., the heating unit, such as a furnace or a boiler and/or a hot water heater). The present invention conducts that analysis and also examines the basis of that usage through inclusion of the second sensor set 14.

Sensor 12a of the first sensor set 12 is coupled to a burner 28, sensor 12b is coupled to a fuel valve 30, and/or sensor 12c is coupled to a heating fluid conduit 32. It is noted that sensor 12c is optional. It is also noted that a sensor of the first sensor set 12 may be coupled to a CAD cell of the burner 28 used to determine whether a flame exists in the heating unit 20 when the burner 28 is operating. In this example, fuel from fuel tank 34 delivers fuel to the burner of the heating unit 20 through conduit 36, the heating unit 20 generates a heating fluid such as water or air and transfers that heating fluid through conduits 32 to heat outlets 38 located in one or more rooms of a building. Sensor 14a of the second sensor set 14 is coupled to a first thermostat 40, sensor 14b is coupled to second thermostat 42 and sensor 14c is coupled to third thermostat 44. Thermostats 40-44 may be any sort of device used to detect temperature conditions within a room and building and in communication with the burner 28 such as through wiring 46 or other means including wireless communication, to effect operation of the burner 28 and the heating unit 20 to generate heat in the zone associated with that particular thermostat all as is known by those skilled in the art.

The first sensor set 12 is configured to gather information of interest associated with the functioning of any or all of the burner 28, the conduits 32 and the fuel tank 34. That information may include, but not be limited to, fuel level in the fuel tank 34, on, off and time of operation of the burner 28, burner ignition failure, ignition timing, and temperature of the conduit 32 as well as detection of fluid flow within the conduit 32. The second sensor set 14 is configured to gather information of interest associated with the functioning of the thermostats 40, 42 and 44. That information may include, but not be limited to, the detection of signals indicating the start, stop and duration of a call for heat by signaling primary control of the burner 28. It is noted that use of only the first sensor set 12 will yield information about how much fuel is consumed and how long the burner 28 runs. That is useful information and can be monitored to determine the amount of fuel consumed over a period of time. However, that information does not enable analysis of which heating zone is calling for heat and, through that analysis, insight into conditions in the room or building reflected by the output of the thermostats sensed by the second sensor set 14.

The signal processor 16 is configured to receive information from the first sensor set 12 and the second sensor set 14. It may also receive additional input from other sensors and inputs, whether introduced manually or through one or more other devices. The signal processor 16 may be coupled to the first sensor set 12 and the second sensor set 14 by wire or wirelessly. For example, the first sensor set 12, the second sensor set 14 and the signal processor 16 may include radio signal functionality in which signals are exchanged through associated transceivers 50, for example. As a result, signal exchange may occur locally or remotely. That is, the signal processor 16 and the computing device 18 may be located at the building where the sensor sets 12 and 14 reside or they be located at a different location.

The signal processor 16 is coupled to the computing device 18 and may form a part of it. The computing device 18 is configured to receive data transferred from the signal processor 16, which data are developed from signals produced by the first sensor set 12 and the second sensor set 14. The computing device 18 is configured to perform functions including gathering of sensed data, analyzing the sensed data to determine fuel consumption, device operation and room or building conditions. The computing device 18 is further configured to enable the performance of functions including data aggregation for building-wide analysis and multi-building analysis such as through an internet-based data aggregation and analysis mechanism, for example. Other functions may be established in the computing device 18 to make an array of determinations of interest directly or indirectly through access to the data provided by the first sensor set 12 and the second sensor set 14, as well as other input from other sources.

The computing device 18 may also be configured to generate output information directed to the signal processor 16 to be used in querying one or more of the sensors of the first and second sensor sets 12 and 14 for additional information of interest, and to manage operation of one or more of the thermostats 40-44, the burner 28, or a part of the heating unit 20. When the fuel used to supply the burner 28 is one that requires the use of a burner motor, the controller 16 may be configured to receive information from the motor, such as time of operation, and transmit that information to the processor 18 to add to the set of data used to determine system efficiency, for example.

The system 10 of the present invention includes a method carried out by a set of functions through a computing system to provide information about fuel usage and the equipment and space where the fuel usage occurs. The computing system is programmed to perform functional steps associated with the method described herein. The computing system may be associated with local or remote computing means, such as one or more central computers, such as server in a local area network, a metropolitan area network, a wide area network, or through intranet and internet connections. Details specific to the heating system, such as BTU rating, pump pressure, nozzle size, boiler type and the like may not be processed solely or at all by the computing device 18. Instead, high level analyses using such information may be carried out remotely on a larger processing environment associated with the computing system rather than just the computing device 18 but that remains an option.

The computer system may include one or more discrete computer processor devices, including for example, the computing device 18. Examples of known computing devices that may be suitable for use with the invention include, but are not limited to, personal computers, server computers, hand-held or laptop devices, cellular phones including smart phones, multiprocessor systems, microprocessor-based systems, set top boxes, programmable consumer electronics, network PCs, microcontrollers, minicomputers, mainframe computers, distributed computing environments that include any of the above systems or devices, and the like. The computer system may include computer devices operated by one or more users, such as through a desktop, laptop, or servers, smart devices such as smart phones but not limited thereto and/or one or more providers of services corresponding to one or more functions of the invention. One or more of the computing apparatuses identified herein for the purpose of performing the functions described may be internet (cloud) based. That is, the invention may be characterized as a software-based invention with implementation occurring across an array of physical computing devices some or all of which may be located locally, remotely or both.

The server, the computer processor, or a combination of both may be programmed to include the functions of the system 10. One or more relational databases that may be associated with the server, the computer processor, other computing devices, or any combination thereof, include information related to the fuel consumption and fuel demand. For example, the database includes information associated with a specific burner, a specific thermostat, a set of thermostats, a set of burners, and building configuration and insulation. The relational database of the present invention is used for gathering, storing and making accessible fuel usage and demand information. For the purpose of the description of the present invention, a database is a collection of stored data that are logically related. Although there are different types of databases, and the database of the present invention may be any of such types, it is preferably a relational database with a relational database management system, comprising tables made up of rows and columns. Data stored in the relational tables are accessed or updated using database queries submitted to the database system. The database may be populated and updated with information provided by an application provider capable of carrying out one or more of the steps associated with the system of the invention.

The invention may be described in the general context of computer-executable instructions, such as program modules, being executed by a computer. Generally, program modules include routines, programs, objects, components, data structures, etc. that perform particular tasks or implement particular abstract data types. As indicated above, the system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices. Storage of program instructions and database content may thereby be cloud-based as they can be stored on remote servers and accessed through internet-based connections. Access may occur through wiring or wirelessly.

The computer system may be configured and arranged to perform the described functions and steps embodied in computer instructions stored and accessed in ways known to those of skill in the art of computer programming and information processing. The functions and steps, such as the functions and steps of the method of the present invention described herein, individually or in combination, may be implemented as a computer program product tangibly as computer-readable signals on a computer-readable medium. Such computer program product may include computer-readable signals tangibly embodied on the computer-readable medium, where such signals define instructions, for example, as part of one or more programs that, as a result of being executed by the computer system, instruct the computer system to perform one or more processes or acts described herein, and/or various examples, variations and combinations thereof. Such instructions may be written in any of a plurality of programming languages, whether functional on a mainframe computer, a minicomputer, a tablet or a mobile computing device but not limited thereto. The computer-readable medium on which such instructions are stored may reside on one or more of the computing devices described above and may be distributed across one or more such devices.

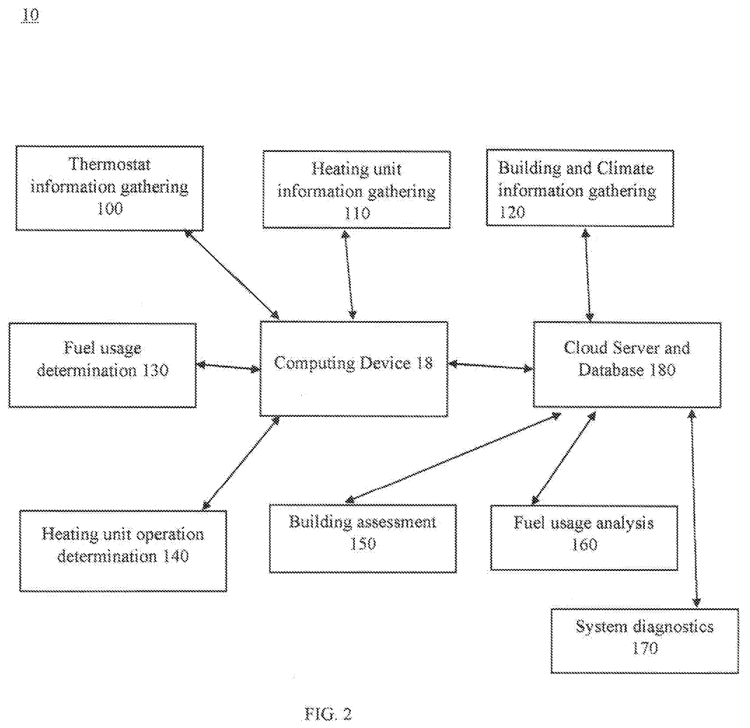

As represented in FIG. 2, the computer system including the computing device 18 is used to carry out several primary functions that enable effective fuel usage information. Those primary functions include a thermostat information gathering function 100, a heating unit information gathering function 110, a building and climate information gathering function 120, a fuel usage determination function 130, a heating unit operation determination function 140, a building assessment function 150, a fuel usage and demand analysis function 160, and a heating system diagnostics function 170. The computing device 18 is coupled directly or indirectly to the components of the system 10 previously described with reference to FIG. 1 and is further coupled to a server such as an internet or cloud-accessed server and a database via cloud server and database function 180.

The thermostat information gathering function 100 gathers data dynamically from one or more of the sensors of the second sensor set 14. That information includes, but is not limited to, on/off cycles. The information delivered to the computing device 18 may be as simple as a time count between on and off times of the thermostats to which the sensors 14a-14c are coupled. The data are stored in the database and metadata may be applied to that data including, but not limited to, thermostat location, date and time of day when data was gathered. The information gathered by the thermostat information gathering function 100 is used in conjunction with other information of the system 10.

The heating unit information gathering function 110 gathers data dynamically from one or more of the sensors of the first sensor set 12 associated with the heating system of the building, which as previously noted includes the heating unit, the burner, the fuel tank and any hot water heater that may exist in the building. That information includes, but is not limited to, burner on/off cycles, fuel gauge readings and temperature readings. The information delivered to the computing device 18 may be a time count between on and off times of the burner motor when a burner motor is part of the heating system and/or burner control valve, and/or gauge information from the fuel tank 34 over time. The data are stored in the database and metadata may be applied to that data including, but not limited to, sensor location, date and time of day when data were gathered. The information gathered by the heating unit information gathering function 110 is used in conjunction with other information of the system 10.

The building and climate information gathering function 120 gathers data about the building within which the system 10 is located. It can also include transmittal of degree days that may be of use in a fuel usage and/or demand determination. That information may be static, such as building and room dimensions and insulation values, and it may be dynamic, such as heat loss gathered from measurements taken at selectable locations around the building over time. The information delivered to the computing device 18 may be provided manually, such as with the building dimensions, and by sensor interface such as when determining heat loss information. The data are stored in the database and metadata may be applied to that data including, but not limited to, room, and date and time of day when data was gathered. The information gathered by the building and climate information gathering function 120 is used in conjunction with other information of the system 10.

The fuel usage determination function 130 is configured to provide an accurate and reliable determination of how much fuel has been consumed for relatively short periods of time, such as that associated with a burner run cycle. That information can be useful in the scheduling of fuel delivery when used in combination with other data. Specifically, the fuel usage determination function 130 is configured to gather from the database information including fuel gauge values, burner motor operation periods when a burner motor exists, and, optionally, heating fluid conduit flow. The fuel usage determination function 130 is configured to calculate actual fuel usage based on that collected data and such other information deemed to be of value in determining how much fuel has been used to heat a building over a time period.

From this information, in-tank fuel volume can be determined from the calculation of starting tank volume—fuel consumed. Fuel consumed is calculated as the hours of burner on-time multiplied by the burn rate. The hours of burner on-time are relative to when the starting volume was taken. The burn rate (volume per hour) is based on the burner nozzle size and pump pressure. Nozzle manufacturers provide the data to support this calculation. The burn rate provides consumption accuracy that is within 95% of actual (based on a manufacture's rate chart). It is possible to improve accuracy by adjusting the burn rate using observed rates. That is to say, if you have a known number of hours of run time and known measure of consumption, an actual burn rate can be calculated. This can be averaged into the theoretical burn rate to fine tune the rate for a particular burner.

The heating unit operation determination function 140 is configured to assess whether the heating unit, including its components, is operating at expected efficiency and to detect any drop-off in that efficiency. Specifically, the heating unit operation determination function 140 is configured to gather from the database information including burner motor operation periods (when a burner motor exists), heating fluid conduit flow and temperature conditions, and thermostat feedback data. The heating unit operation determination function 140 is configured to calculate whether a change in efficiency of the entire system is caused by events other than heating unit operation, such as a particular room of the building losing insulation rather than the operation of the burner itself. Prior to the present invention, a drop-off in burner efficiency could only be broadly determined. The heating unit operation determination function 140 uses more detailed data to make a more granular determination of heating unit operation including burner operation. In addition, this function may be configured to gather such data across multiple heating unit systems and/or multiple buildings to provide a broader analysis of manufactured heating unit system quality on a broader scale, and to enable detection of possible failure effects to improve maintenance activities, including to anticipate specific failure modes.

The building assessment function 150 is configured to assess building-wide fuel consumption and room-by-room fuel consumption associations. The building assessment function 150 obtains data from the database transmitted by the first sensor set 12 and the second sensor set 14, as well as from the building information gathering function 130. Specifically, demand is evaluated by room and throughout the building based on thermostat activity and fuel usage. This can also be run as a comparison of thermostat activity from one thermostatic zone to another. This assessment may also optionally be run across multiple buildings. Prior to the present invention, the reasons for changes in expected fuel consumption could only be assessed on a broad scale, with insulation activities implemented widely through the building rather than being targeted to those particular rooms where fuel consumption was excessive. The building assessment function 150 can also be used to detect errors in operation of individual thermostats and, as a result on a broader scale, thermostat reliability and effectiveness can be determined across product lines.

The building assessment function 150 “watches” over a heating system, which most typically supports the heating needs of a single building. By individually monitoring the thermostatic zone demands using the second set of sensors 14, it is possible to detect deviations from normal, expected demand by heating zone. The basis for making such a determination includes identifying heating demand time relative to heating degree days, to derive a degree-based demand coefficient. Expected demand can then be determined by using recent heating degree day data times the demand coefficient. Actual demands that exceed expectations beyond a reasonable threshold, either above or below, indicate a potential system issue within a particular zone. For instance, a thermostat malfunction that fails to demand heat could lead to this condition and be detected as a potential system issue.

The fuel usage analysis function 160 is configured to provide a comprehensive overview of the fuel consumption activities building-wide and by thermostatic zone. Specifically, all or any selectable portion of the data gathered from all sensors, manually entered information, and other sensors coupled to the components of heat generation described herein are used to determine fuel usage and fuel demand.

The thermal output of a burner is considered to be constant throughout its run cycle. The heat load for a thermostatic zone can be described as a percentage of total burner thermal capacity. This is approximated by identifying the ratio between burner on time and zone demand time. A heat demand that last 60 minutes, requiring 30 minutes of burner run time, would represent a 50% heat load of total burner capacity. Deriving a heating load percentage for each of the thermostatic zones may be done by observing actual run times and associated demand times. This is easily accomplished when zone demands are isolated, so as to not overlap each other. When the demands overlap, a calculation can be made based on a determination of the influence of each respective thermostatic zone on the overall demand of the overlapping zones. With the zone loading percentages known, it becomes a rudimentary process to allocate burner run time across the zones based on which zones are demanding at the time the burner is running. The burner is always supplying 100% of its potential and the zones are sharing that potential based on the weighting of the zone loadings. For instance, if two zones are demanding concurrently and zone 1 is a 50% load and zone 2 is a 70% load, then zone 1 is supplied with 42% of the thermal output (0.5/(0.5+0.7)) while zone 2 is receiving the remaining 58% (0.7/(0.5+0.7)). Being able to allocate hours of burner run time to each of the zones provides a basis for estimating product consumption by zone, using the previously described methods for run time to gallon conversion.

The system 10 of the present invention monitors run-time by watching a fuel valve (not just a burner motor when one exists), for better accuracy, because a burner motor can run without fuel flowing. In addition to measuring fuel consumption, the system 10 does so in conjunction with reasons for consumption (i.e., demand). Combined, these two dimensions of data provide insight into system efficiency and costs associated with heating various zones within the home as well as heating of hot water. Having these two dimensions allows for tracking of the heating system cycles. For instance, a thermostat demand initiates a heating system cycle that will last until the demand is satisfied and the burner turns off. A single cycle can consist of many burner on/off events and can satisfy more than one demand. These cycle events are unique to the home and heating system and provide data that can identify system problems or inefficiencies.

The system 10 also uses the fuel consumption and fuel demand dimensions of data to detect system failures through the heating system diagnostics function 170. The computing device 18 is coupled directly or indirectly to the components of the system 10 previously described with reference to FIG. 1. For instance, data over time provide normal trends for heat and hot water run times, such that significant deviations from them can trigger notification events. Issues, such as thermostat demand that is not met within a nominal amount of time, or thermostatic zone that has not demanded heat for too long. The system 10 is also capable of comparing consumption rates with other heating systems, such as comparing fuel used to heat hot water on a daily basis. The comparison with homes can be for similar types of systems, or against all systems.

The efficiency of a particular heating system can be measured to such a degree through the system diagnostics function 170 and one or more of the other functions described herein that variances in that efficiency will be detectable over time. Common to fuel oil heating systems is soot build up that diminishes system efficiency. A system clean/tune-up will restore it to peak operating efficiency. That efficiency gain is expected to be visible in the data as reduced run times. As noted, the system 10 logs a third dimension of data, which is date and time. Demand can vary by time of day and can be cyclical in nature based on lifestyles. This can provide a way to see usages variances due to activities like daily showering, or room temperature adjustment at night and in the morning.

The system 10 is configured through one or more of the described functions to track on/off burner cycles by considering a cycle to be related to heat demand Start and End, so both Consumption and Reason for Consumption are explainable. In this way, the system 10 can identify Demand Cycles, which can consist of multiple burner cycles. This provides insight into the demand of heating the living space, rather than just heating the boiler. Furthermore, gaining an understanding of heat demand for the living space relative to degree days provides a factor that allows for prediction of demand, which can be used to identify issues with a heating zone such as unexpected demand, missing demand, or demand that grows over time indicating efficiency loss. Information gathered through the sensor sets may be transmitted by the computing device 18 to which they are coupled to the database or other selectable locations through the cloud server and database function 180 using well known signal exchange devices and operations.

In one example of the use of the system 10, sensing of the fuel burner and of a plurality of thermostats in various sections of a building, the burner ran on and off for a period of time. During that period, a first thermostat signaled demand on and off several times, while a second thermostat maintained an on-demand condition throughout the entire period. That information was diagnosed to make an assessment that the particular thermostat was running improperly, that there was a difficulty in the delivery of the heating fluid to and from that zone or that the temperature of the fluid in the boiler was too low. Whereas simply sensing the condition of the boiler during the specified period may not have given any indication that there was some type of error in the system, the combination of sensing fuel consumption and demand information resulted in a diagnosis pinpointing several potential problem locations that would not have otherwise been detected.

In a second example of use of the system 10, a sensor of the first sensor set detected that a burner failed to start within a specified period of time. That sensed information was gathered but not reported to the building owner. It was not until several hours later that the building owner detected the building being colder than expected and then discovered the burner outage. A transmission of the detected outage by one of the first set sensors would have signaled the building owner much sooner about the burner failure and heat could have been restored more quickly, and possible damage from pipe freeze would have been avoided with greater certainty.

In a third example of use of the system 10, a sensor of the second sensor set identified short, high frequency demands being made in a thermostatic zone. It is known that high frequency demands or calls to a heating unit can be detrimental to the longevity of the heating unit. The sensed excess demand call in the thermostat zone was discovered and it was determined that the thermostatic was faulty and required replacement. That determination resulted in an ease of burden placed on the heating system for that building.

While the invention has been described with respect to specific embodiments, it is to be understood that it is not limited to those specific embodiments. Instead, the invention is defined by the appended claims and reasonable equivalents.

What is claimed is:

1. A computer-implemented system configured to analyze operation of a heating system of a building based on fuel consumption and fuel demand of the building, wherein the heating system includes a heating unit and one or more thermostats associated with one or more thermostatic zones of the building, the system comprising:
a signal processor arranged for access to the internet and having stored thereon computer-executable instructions configured to acquire information and to transmit that information to one or more computer devices;
a database of information accessible through the one or more computing devices, wherein the information of the database includes information about the heating system of the building;
a first sensor set coupled to the signal processor, to the heating unit and/or arranged to gather fuel consumption information;
a second sensor set coupled to the signal processor and to the one or more thermostats arranged to gather fuel demand information within the building; and
a fuel usage and demand analysis function of the one or more computing devices configured to analyze data from the first sensor set and from the second sensor set to output a determination of operation of the heating system based on consumption information and demand information.

2. The system of claim 1 wherein the first sensor set includes a first sensor coupled to a heating unit burner motor and a second sensor coupled to a fuel tank.

3. The system of claim 1 wherein the fuel usage analysis function is further configured to enable operational assessment of the heating unit.

4. The system of claim 1 wherein the fuel usage analysis function is further configured to enable assessment of fuel demand variations across the thermostatic zones of the building.

5. The system of claim 1 further comprising a signal transmitter for transmitting the gathered fuel information and gathered demand information to the one or more computing devices.

6. A method of analyzing fuel consumption and demand information associated with operation of a heating system of a building to identify one or more characteristics of the heating system, wherein the heating system includes a heating unit and one or more thermostats associated with one or more thermostatic zones of the building, the method comprising the steps of:
gathering data about the heating unit and/or the building;
sensing first information about operation of the heating unit;
sensing second information about the one or more thermostatic zones; and
analyzing the gathered data, the first information and the second information to determine operational information about the furnace, the one or more thermostatic zones or both.

7. The method of claim 6 wherein the step of sensing first information includes coupling one or more sensors of a first sensor set to the heating unit and/or to a fuel tank coupled to the heating unit.

8. The method of claim 6 wherein the step of sensing second information includes coupling one or more sensors of a second sensor set to the one or more thermostats of the building.

9. The method of claim 6 wherein the step of analyzing the gathered data, the first information and the second information includes conducting a systems diagnostics analysis to identify any problems associated with the heating unit, the one or more thermostats or both.

10. The method of claim 6 further comprising the step of transmitting the first information and the second information to a computing system capable of carrying out the analyzing step.
